(19) United States
(12) Patent Application Publication
(10) Pub. No.: US 2017/0288482 A1
(43) Pub. Date: Oct. 5, 2017

(54) PERMANENT MAGNET TYPE ROTATING ELECTRICAL MACHINE

(71) Applicant: KABUSHIKI KAISHA TOYOTA JIDOSHOKKI, Aichi (JP)

(72) Inventors: Noriyuki SUZUKI, Kariya-shi (JP); Yoshiyuki NAKANE, Kariya-shi (JP)

(73) Assignee: KABUSHIKI KAISHA TOYOTA JIDOSHOKKI, Aichi (JP)

(21) Appl. No.: 15/469,913

(22) Filed: Mar. 27, 2017

(30) Foreign Application Priority Data
Mar. 31, 2016 (JP) 2016-072521

(51) Int. Cl. H02K 1/27; H02K 21/04; H02K 21/12; H02K 1/28

(52) U.S. Cl. CPC H02K 1/2706; H02K 1/28; H02K 21/046; H02K 21/12; H02K 2201/06

(57) ABSTRACT

A permanent magnet type rotating electrical machine includes a stator, a rotor core having first and second magnet inserting holes, and permanent magnets. A partition wall is defined between a first end of each of the first magnet inserting holes and a second end of the associated one of the second magnet inserting holes. In a section radially outward of the first and second ends, a bulging portion is arranged between a surface extending along the permanent magnet in the magnet inserting hole and a surface of the partition wall. The bulging portion has a first curved surface continuous with the surface of the partition wall and a second curved surface continuous with the surface extending along the permanent magnet in the first magnet inserting hole or the second magnet inserting hole. The curvature of the first curved surface is smaller than the curvature of the second curved surface.

### BACKGROUND OF THE INVENTION

The present invention relates to a permanent magnet type rotating electrical machine and, more particularly, a permanent magnet type rotating electrical machine in which a plurality of permanent magnets are embedded in a rotor core.

In a permanent magnet type rotating electrical machine (an interior permanent magnet (IPM) motor), permanent magnets are embedded in a rotor core (an iron core). Each of the permanent magnets is magnetized such that the magnetizing direction corresponds to the thickness direction. The rotor core has multiple pairs of embedding holes. Two permanent magnets are embedded in each pair of the embedding holes substantially in a V shape spreading outward in a radial direction of a rotor. A partition wall (a support post) is arranged between each two adjacent embedding portions. The centrifugal force causes great stress to act on the end of each of the partition walls on the outer side in the radial direction of the rotor core.

Conventionally, a motor has been known that has a configuration for restraining the stress acting on the end of each partition wall on the radially outer side. As shown in FIG. 4, a partition wall 57 is arranged between two magnet installing portions 51, which are provided in a rotor core 50. In the magnet installing portions 51, ends 51a adjacent to the partition wall 57 project toward each other substantially in arcuate shapes. Permanent magnets 52 are each inserted in the corresponding one of the magnet installing portions 51. Mold plastic 53, with which the magnet installing portions 51 are filled, fixes the permanent magnets 52 to the rotor core 50.

Japanese Laid-Open Patent Publication No. 2015-149791 discloses another conventional technique. In the conventional technique described in this document, a partition wall 57 is arranged between two magnet installing portions 51 as shown in FIG. 5. The end of each magnet installing portion 51 adjacent to the partition wall 57 includes an arcuate surface 56 and an end surface 54, which extends parallel with the d-axis. Each of the arcuate surfaces 56 connects a surface 55, which extends along a permanent magnet 52 in one of the magnet installing portions 51, to the end surface 54. The permanent magnets 52 are inserted in the magnet installing portions 51. Mold plastic 53, with which the magnet installing portions 51 are filled, fixes the permanent magnets 52 to the rotor core 50.

Generally, increase in the length of each permanent magnet 52 would improve the torque without changing the size (the outer diameter) of the rotor core 50 or reduce the size of the body of the rotor core 50 while maintaining the intensity of the torque that can be output.

As has been described, in the conventional technique of FIG. 4, the two ends 51a adjacent to the partition wall 57 have substantially arcuate shapes projecting toward each other. In this case, to increase the length of each permanent magnet 52, the thickness of the partition wall 57, which is between the two magnet installing portions 51, must be decreased. The necessary strength of the partition wall 57 thus cannot be easily ensured.

In the conventional technique disclosed in FIG. 5, it is preferable to decrease the curvature of each arcuate surface 56 to attenuate the stress acting on the end of the partition wall 57, which is between the two magnet installing portions 51, on the outer side in the radial direction of the rotor core 50. Reduction in the curvature of the arcuate surface 56 reduces the width and the length of each magnet installing portion 51 in the vicinity of the arcuate surface 56 of the magnet installing portion 51. The permanent magnets 52 thus cannot be elongated.

### SUMMARY OF THE INVENTION

Accordingly, it is an objective of the present invention to provide a permanent magnet type rotating electrical machine capable of attenuating stress acting on the radially outer end of a partition wall, which is between permanent magnet accommodating portions, and improving the torque without enlarging the size of the body of the rotor core, in which multiple pairs of permanent magnets are embedded.

To achieve the foregoing objective and in accordance with one aspect of the present invention, a permanent magnet type rotating electrical machine is provided that includes a stator, a rotor core having a plurality of magnet inserting holes, and a plurality of permanent magnets inserted in the magnet inserting holes and fixed to the rotor core. The permanent magnets include a plurality of north-pole magnets each having a north pole on a side opposed to the stator and a plurality of south-pole magnets each having a south pole on a side opposed to the stator. Each two adjacent south-pole magnets configure a first pair. Each two adjacent north-pole magnets configure a second pair. The first and second pairs are fixed to the rotor core to be arranged alternately in a circumferential direction of the rotor core. The magnet inserting holes include south-pole magnet inserting holes that accommodate the two south-pole magnets configuring the first pair and north-pole magnet inserting holes that accommodate the two north-pole magnets configuring the second pair. The south-pole magnet inserting holes include a first magnet inserting hole that accommodates one of the two south-pole magnets and a second magnet inserting hole that accommodates the other one of the two south-pole magnets. The north-pole magnet inserting holes include a first magnet inserting hole that accommodates one of the two north-pole magnets and a second magnet inserting hole that accommodates the other one of the two north-pole magnets. In the first and second magnet inserting holes of the south-pole magnet inserting holes, the first magnet inserting hole has a first end opposed to the second magnet inserting hole, and the second magnet inserting hole has a second end opposed to the first magnet inserting hole. In the first and second magnet inserting holes of the north-pole magnet inserting holes, the first magnet inserting hole has a first end opposed to the second magnet inserting hole, and the second magnet inserting hole has a second end opposed to the first magnet inserting hole. The first magnet inserting hole and the second magnet inserting hole of the south-pole magnet inserting holes are configured identically with the first magnet inserting hole and the second magnet inserting hole of the north-pole magnet inserting holes, respectively. Each first magnet inserting hole and the corresponding second magnet inserting hole are spaced apart such that a partition wall is defined between the first end of the first magnet inserting hole and the second end of the second magnet inserting hole. In a section of each of the first and second ends on an outer side in a radial direction of the rotor core, a bulging portion is arranged between a surface of the partition wall and a surface extending along the permanent magnet in the first magnet inserting hole or the second magnet inserting hole. The bulging portion has a first curved surface continuous with the surface of the partition wall and a second curved surface continuous with the surface extending along the permanent magnet in the first magnet inserting hole or the second magnet inserting hole. The curvature of the first curved surface is smaller than the curvature of the second curved surface.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a cross-sectional view schematically showing a rotating electrical machine;

FIG. 1B is an enlarged view showing part of a rotor;

FIG. 2A is an enlarged view showing part of the rotor;

FIG. 2B is an enlarged view showing the part encircled by the long dashed short dashed circle in FIG. 2A;

FIG. 2C is an enlarged view showing part of a bulging portion corresponding to a south-pole magnet in correspondence with FIG. 2B;

FIG. 3 is a plan view showing part of a rotor of another embodiment;

FIG. 4 is a plan view showing part of a rotor of a conventional technique; and

FIG. 5 is a plan view showing part of a rotor of another conventional technique.

### DETAILED DESCRIPTION OF THE PREFERRED EMBODIMENTS

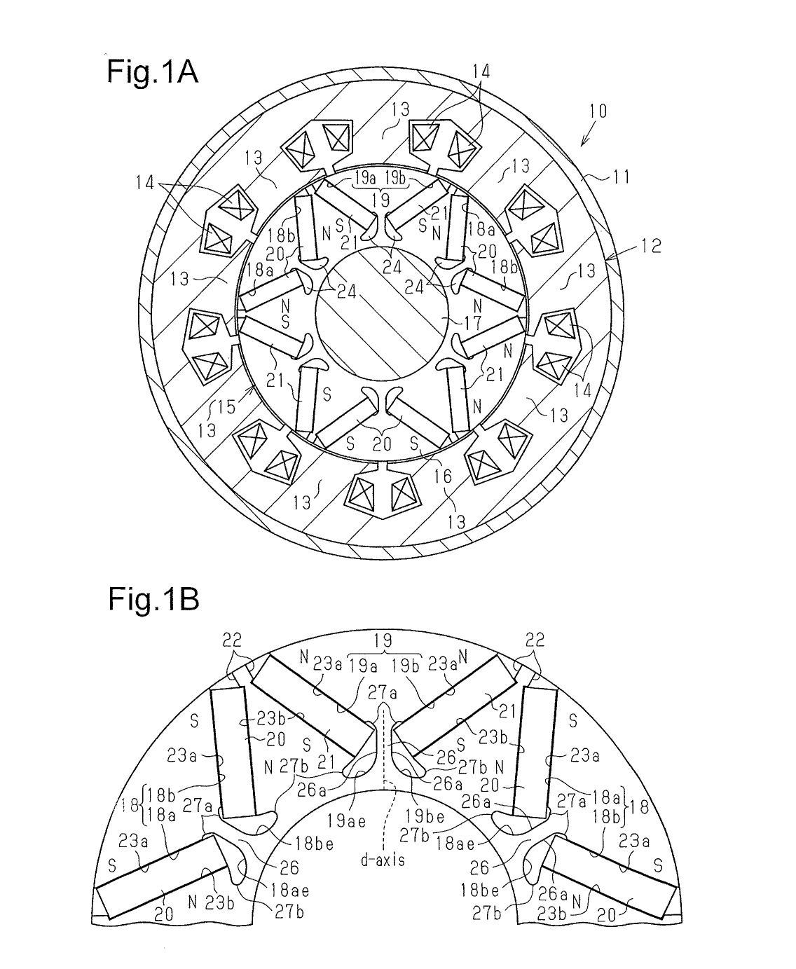

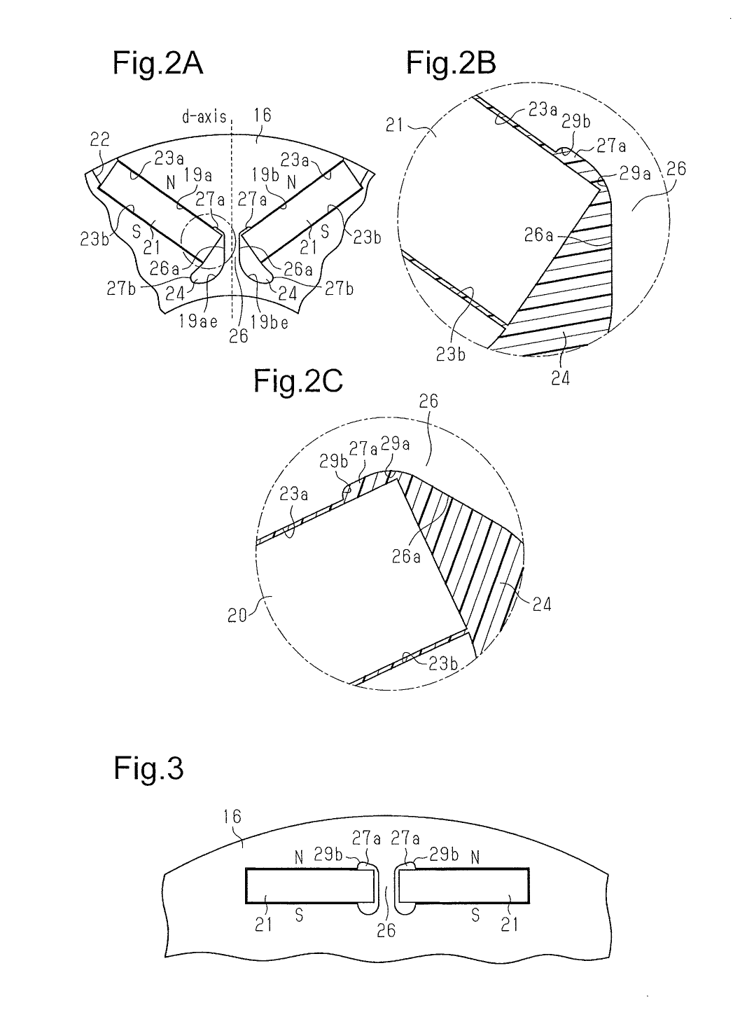

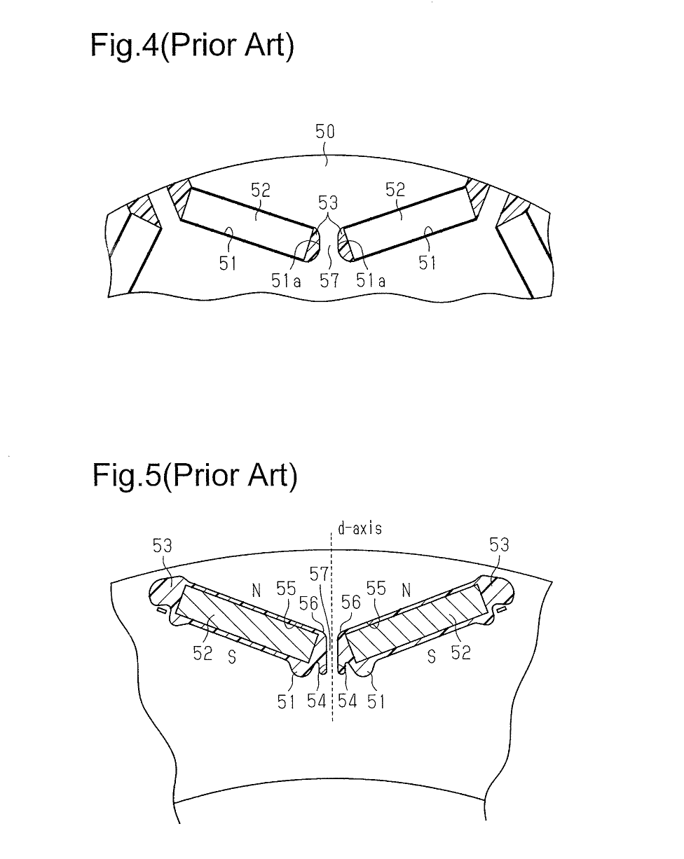

An embodiment of the present invention will now et described with reference to FIGS. 1A, 1B, 2A, 2B, and 2C. In FIGS. 1A, 1B, and 2A, hatching is omitted in certain portions.

As shown in FIG. 1A, in a permanent magnet type rotating electrical machine 10, a stator 12 is fixed to an inner peripheral surface of a housing 11. The stator 12 has a cylindrical shape. The stator 12 has teeth 13, which are spaced apart by regular intervals on the inner side of the stator 12. Coils 14 are wound around the teeth 13.

A rotor 15 is located on the inner side of the stator 12. The rotor 15 has a rotor core 16. The rotor core 16 is configured by stacking a plurality of, for example, several tens of disk-like electromagnetic steel plates together. A rotary shaft 17 is passed through the center of the rotor core 16. The rotary shaft 17 is rotationally supported by the housing 11 with a non-illustrated bearing.

As illustrated in FIGS. 1A and 1B, the rotor core 16 has magnet inserting holes. Permanent magnets are inserted through the magnet inserting holes and fixed to the rotor core 16. Each of the permanent magnets has a rectangular shape. The permanent magnets include north-pole magnets 21, each of which has a north pole on the side opposed to the stator 12, and south-pole magnets 20, each of which has a south pole on the side opposed to the stator 12. Each two adjacent south-pole magnets 20 configure a first pair. Each two adjacent north-pole magnets 21 configure a second pair. The first pairs of the south-pole magnets 20 and the second pairs of the north-pole magnets 21 are fixed to the rotor core 16 to be arranged alternately in the circumferential direction of the rotor core 16.

Specifically, multiple (in this embodiment, six) imaginary areas, which are equally divided in the circumferential direction, are defined on the rotor core 16. Pairs of south-pole magnet inserting holes 18 and pairs of north-pole magnet inserting holes 19 are arranged alternately in the imaginary areas. Two of the south-pole magnets 20, which configure one of the first pairs, are inserted through the corresponding two of the south-pole magnet inserting holes 18. Two of the north-pole magnets 21, which configure one of the second pairs, are inserted through two of the north-pole magnet inserting holes 19. That is, in this embodiment, the permanent magnet type rotating electrical machine 10 is a six-pole rotating electrical machine.

Each two associated south-pole magnet inserting holes 18 include a first magnet inserting hole 18a, which accommodates one of the two corresponding south-pole magnets 20, and a second magnet inserting hole 18b, which accommodates the other one of the south-pole magnets 20. Each two associated north-pole magnet inserting holes 19 include a first magnet inserting hole 19a, which accommodates one of the two corresponding north-pole magnets 21, and a second magnet inserting hole 19b, which accommodates the other one of the north-pole magnets 21.

The first magnet inserting holes 18a and the second magnet inserting holes 18b in each pair of the south-pole magnet inserting holes 18 are respectively configured identically with the first magnet inserting hole 19a and the second magnet inserting holes 19b in each pair of the north-pole magnet inserting holes 19.

Each first magnet inserting hole 18a (19a) and each second magnet inserting hole 18b (19b) both include a first surface 23a and a second surface 23b, which are surfaces extending along the long sides of the corresponding south-pole magnet 20 or the corresponding north-pole magnet 21. The first surface 23a is arranged outward with respect to the second surface 23b in the radial direction of the rotor core 16.

Each of the first magnet inserting holes 18a (19a) and the associated one of the second magnet inserting holes 18b (19b) are arranged to configure a V shape spreading outward in the radial direction of the rotor core 16. Each two associated south-pole magnets 20 configuring a first pair and each two associated north-pole magnets 21 configuring a second pair are both arranged in a V shape spreading outward in the radial direction of the rotor core 16. Each south-pole magnet 20 is sealed by mold plastic 24 in a state inserted through the corresponding south-pole magnet inserting hole 18. Each north-pole magnet 21 is fixedly sealed by mold plastic 24 in a state inserted through the corresponding north-pole magnet inserting hole 19. Only FIGS. 2B and 2C show the mold plastic 24 as hatched.

Of the opposite ends of each south-pole magnet inserting hole 18 in the longitudinal direction of the corresponding south-pole magnet 20, the end on the outer side in the radial direction of the rotor core 16 is open. The end of the south-pole magnet inserting hole 18 on the outer side in the radial direction of the rotor core 16 is the end on the side opposite to the end of the first magnet inserting hole 18a opposed to the second magnet inserting hole 18b or the end on the side opposite to the end of the second magnet inserting hole 18b opposed to the first magnet inserting hole 18a. Stopper portions 22 (shown with the reference numeral in FIG. 1B) are provided in opening portions to restrict movement of the south-pole magnets 20 from the south-pole magnet inserting holes 18 toward the opening ends.

Of the opposite ends of each north-pole magnet inserting hole 19 in the longitudinal direction of the corresponding north-pole magnet 21, the end on the outer side in the radial direction of the rotor core 16 is open. The end of the north-pole magnet inserting hole 19 on the outer side in the radial direction of the rotor core 16 is the end on the side opposite to the end of the first magnet inserting hole 19a on the side corresponding to the second magnet inserting hole 19b or the end on the side opposite to the end of the second magnet inserting hole 19b on the side corresponding to the first magnet inserting hole 19a. Stopper portions 22 (shown with the reference numeral in FIG. 1B) are provided in opening portions to restrict movement of the north-pole magnets 21 from the north-pole magnet inserting holes 19 toward the opening ends.

With reference to FIG. 1B, each of the first magnet inserting holes 18a (19a) and the associated one of the second magnet inserting holes 18b (19b) are spaced apart such that a partition wall 26 is defined between a first end 18ae (19ae) of the first magnet inserting hole 18a (19a) and a second end 18be (19be) of the second magnet inserting hole 18b (19b). In other words, the partition wall 26 is provided between the end of the first magnet inserting hole 18a (19a) on the inner side in the radial direction of the rotor core 16 of the opposite ends of the first magnet inserting hole 18a (19a) in the longitudinal direction of the permanent magnet (the south-pole magnet 20 or the north-pole magnet 21) and the end of the second magnet inserting hole 18b (19b) on the inner side in the radial direction of the rotor core 16 of the opposite ends of the second magnet inserting hole 18b (19b) in the longitudinal direction of the permanent magnet (the south-pole magnet 20 or the north-pole magnet 21).

Each partition wall 26 is defined by surfaces 26a, which are each configured to extend in the radial direction of the rotary shaft 17, or extend linearly.

As illustrated in FIG. 1B, each of the first and second ends 18ae, 18be has, in a section on the outer side in the radial direction of the rotor core 16, a first bulging portion 27a arranged between the first surface 23a and the surface 26a of the corresponding partition wall 26. The first bulging portion 27a bulges outward in the radial direction of the rotor core 16 from the first surface 23a and the surface 26a of the partition wall 26.

Referring to FIGS. 1B and 2B, each of the first and second ends 19ae, 19be has, in a section on the outer side in the radial direction of the rotor core 16, a first bulging portion 27a arranged between the corresponding first surface 23a and the surface 26a of the corresponding partition wall 26. The first bulging portion 27a bulges outward in the radial direction of the rotor core 16 from the first surface 23a and the surface 26a of the partition wall 26.

As illustrated in FIG. 2B, the first bulging portion 27a of each north-pole magnet inserting hole 19 has a first curved surface 29a, which is continuous with the surface 26a of the corresponding partition wall 26, and a second curved surface 29b, which is continuous with the first surface 23a. The curvature of the first curved surface 29a is smaller than the curvature of the second curved surface 29b. The second curved surface 29b extends outward in the radial direction of the rotor core 16 from the first surface 23a before being curved to be continuous with the first curved surface 29a. Since the first bulging portion 27a of each south-pole magnet inserting hole 18 is shaped identically with the first bulging portion 27a of each north-pole magnet inserting hole 19, description of the first bulging portion 27a of the south-pole magnet inserting hole 18 is omitted herein.

Each of the first and second ends 18ae, 18be has, in a section on the inner side in the radial direction of the rotor core 16, a second bulging portion 27b arranged between the second surface 23b and the surface 26a of the corresponding partition wall 26. That is, in each of the first and second ends 18ae, 18be, the second bulging portion 27b is located on the side opposite to the associated first bulging portion 27a. Each of the second bulging portions 27b bulges inward in the radial direction of the rotor core 16. The second bulging portion 27b, which is configured identically with the aforementioned second bulging portions 27b, is arranged also in a section of each of the first and second ends 19ae, 19be on the inner side in the radial direction of the rotor core 16. That is, in each of the first and second ends 19ae, 19be, the second bulging portion 27b is located on the side opposite to the corresponding first bulging portion 27a.

Specifically, the section of each of the first and second ends 18ae, 18be on the inner side in the radial direction of the rotor core 16 and the section of each of the first and second ends 19ae, 19be on the inner side in the radial direction of the rotor core 16 do not necessarily have to bulge.

Operation of the permanent magnet type rotating electrical machine 10, which is constructed as above, will hereafter be described.

When the permanent magnet type rotating electrical machine 10 is driven in a loaded state, an electric current is supplied to each coil 14 of the stator 12 to produce a rotating magnetic field in the stator 12, and the rotating magnetic field acts on the rotor 15. As a result, the magnetic attractive force and the repulsive force between the rotating magnetic field and the south-pole magnets 20 and the north-pole magnets 21 cause the rotor 15 to rotate synchronously with the rotating magnetic field.

When the rotor 15 rotates, the centrifugal force causes concentration of the stress on the end of each partition wall 26 on the outer side in the radial direction of the rotor core 16. As has been described in the background art, if, without providing the first bulging portions 27a, the curvature of a surface of each magnet inserting hole adjacent to the corresponding partition wall is decreased to attenuate the stress, the width of the permanent magnet in the magnet inserting hole is decreased. This hampers enlargement of the size of the permanent magnet.

In contrast, in the present embodiment, the first bulging portions 27a are each arranged between the associated first surface 23a and the surface 26a of the corresponding partition wall 26. Each of the first bulging portions 27a has a first curved surface 29a, which is continuous with the surface 26a of the corresponding partition wall 26, and a second curved surface 29b, which is continuous with the first surface 23a extending along the south-pole magnet 20 (the north-pole magnet 21) in the corresponding first magnet inserting hole 18a (19a). The curvature of the first curved surface 29a is smaller than the curvature of the second curved surface 29b.

Therefore, even if the curvature of each first curved surface 29a is decreased to attenuate the stress acting on the end of the corresponding partition wall 26 in the radial direction of the rotor core 16, the length of each of the south-pole magnets 20 and the north-pole magnets 21 is increased. Also, since the curvature of each first curved surface 29a is smaller than the curvature of each second curved surface 29b, the gap is reduced in size. As a result, without enlarging the size of the body of the rotor core 16, the stress acting on the end of each partition wall 26 on the outer side in the radial direction of the rotor core 16 is attenuated, and the torque is increased.

Further, the surface 26a of each partition wall 26 has a linear shape extending in the radial direction of the rotary shaft 17. As a result, compared to a case in which the surface 26a of the partition wall 26 is an arcuate surface without the first bulging portions 27a, the length of each of the south-pole magnets 20 and the north-pole magnets 21 is increased to further increase the torque of the rotating electrical machine.

The present embodiment achieves the following advantages.

(1) The permanent magnet type rotating electrical machine 10 has a stator 12, a rotor core 16 having multiple magnet inserting holes, and multiple permanent magnets, which are inserted through the magnet inserting holes and fixed to the rotor core 16. The magnet inserting holes include south-pole magnet inserting holes 18 and north-pole magnet inserting holes 19. The permanent magnets include multiple south-pole magnets 20 and multiple north-pole magnets 21.

The permanent magnets include multiple north-pole magnets 21, each of which has a north pole on the side opposed to the stator 12, and multiple south-pole magnets 20, each of which has a south pole on the side opposed to the stator 12. Each two adjacent south-pole magnets 20 configure a first pair. Each two adjacent north-pole magnets 21 configure a second pair. The first pairs of the south-pole magnets 20 and the second pairs of the north-pole magnets 21 are fixed to the rotor core 16 to be arranged alternately in the circumferential direction of the rotor core 16.

The magnet inserting holes include south-pole magnet inserting holes 18 and north-pole magnet inserting holes 19. Each two associated of the south-pole magnet inserting holes 18 accommodate the two of the south-pole magnets 20 configuring a corresponding first pair. Each two associated of the north-pole magnet inserting holes 19 accommodate two of the north-pole magnets 21 configuring a second pair. Each two associated of the south-pole magnet inserting holes 18 include a first magnet inserting hole 18a, which accommodates one of the two corresponding south-pole magnets 20, and a second magnet inserting hole 18b, which accommodates the other one of the south-pole magnets 20. Each two associated of the north-pole magnet inserting holes 19 include a first magnet inserting hole 19a, which accommodates one of the two corresponding north-pole magnets 21, and a second magnet inserting hole 19b, which accommodates the other one of the north-pole magnets 21.

Each first magnet inserting hole 18a (19a) has a first end 18ae (19ae) opposed to the associated second magnet inserting hole 18b (19b). Each second magnet inserting hole 18b (19b) has a second end 18be (19be) opposed to the associated first magnet inserting hole 18a (19a).

Each first magnet inserting hole 18a (19a) and the associated second magnet inserting hole 18b (19b) are spaced apart such that the corresponding partition wall 26 is defined between the first end 18ae (19ae) of the first magnet inserting hole 18a (19a) and the second end 18be (19be) of the second magnet inserting hole 18b (19b).

Each of the first and second ends 18ae, 18be (19ae, 19be) has, in a section on the outer side in the radial direction of the rotor core 16, a first bulging portion 27a arranged between the associated first surface 23a, which extends along the permanent magnet in the first or second magnet inserting hole 18b (19b), and the surface 26a of the corresponding partition wall 26. The first bulging portion 27a has a first curved surface 29a, which is continuous with the surface 26a of the partition wall 26, and a second curved surface 29b, which is continuous with the first surface 23a extending along the permanent magnet in the first magnet inserting hole 18a (19a) or the second magnet inserting hole 18b (19b). The curvature of the first curved surface 29a is smaller than the curvature of the second curved surface 29b.

As a result, compared to a case in which a surface of each partition wall 26 between the corresponding first magnet inserting hole 18a (19a) and the associated second magnet inserting hole 18b (19b) is an arcuate surface, the length of each of the permanent magnets (the south-pole magnets 20 and the north-pole magnets 21) is increased to further improve the torque of the rotating electrical machine. Also, the stress acting on the end of each partition wall 26 on the outer side in the radial direction of the rotor core 16, on which the stress of the corresponding permanent magnet tends to act most intensely, is attenuated. Therefore, even if the length of each permanent magnet is increased without enlarging the size of the body of the rotor core 16, which has the above-described configuration, the stress acting on the partition wall of the corresponding permanent magnet accommodating portion (the corresponding one of the south-pole magnet inserting holes 18 and the north-pole magnet inserting hole 19) is attenuated and the torque is improved.

(2) Each two associated permanent magnets (the south-pole magnets 20 and the north-pole magnets 21), which configure a first or second pair, are arranged in a V shape spreading outward in the radial direction of the rotor core 16. Each two associated permanent magnets configuring a pair, which are two permanent magnets (the south-pole magnets 20 and the north-pole magnets 21) configuring a first or second pair, do not necessarily have to be arranged in a V shape spreading outward in the radial direction of the rotor core 16 and may be arranged linearly, for example. However, for the rotor cores 16 having bodies of the same size (the same outer diameter), the V-shaped arrangement ensures comparatively great increase in the length of each permanent magnet and comparatively great improvement of the torque of the rotating electrical machine. Also, for the rotating electrical machines outputting the same torque, the V-shaped arrangement ensures comparatively great reduction in the size of the body of the rotor core 16.

The present invention is not limited to the above embodiment, but may be modified as follows.

As shown in FIG. 3, each two associated permanent magnets (in the drawing, two north-pole magnets 21 are shown) may be arranged linearly. Specifically, two associated south-pole magnets 20 or two associated north-pole magnets 21 may be arranged perpendicular to a line extending in the radial direction of the rotor core 16.

The number of pairs of the permanent magnets (the south-pole magnets 20 and the north-pole magnets 21) is not restricted to six but may be any other suitable number that is greater than one. The number of pairs of the permanent magnets is set as needed in correspondence with requirements including the size of the rotor core 16 and the target number of revolutions.

The angle by which each two associated permanent magnets (the south-pole magnets 20 and the north-pole magnets 21) configuring a pair are arranged in a V shape is set as needed in correspondence with requirements including the size of the rotor core 16, the number of the poles, and the target number of revolutions.

Each surface 26a, which defines a partition wall 26, does not necessarily have to be linear in the radial direction of the rotary shaft 17. For example, each surface 26a, which define a partition wall 26, may either be curved or have a shape in which a flat surface and a curved surface are continuous with each other.

The surfaces 26a, which define a partition wall 26, may be asymmetrical.

Each first bulging portion 27a may be either a flat surface or a curved surface between the associated first curved surface 29a and second curved surface 29b.

The optimal values of the bulging amount of each first bulging portion 27a, the curvature of each second curved surface 29b, and the curvature of each first curved surface 29a are not constant but are set variably as needed in correspondence with requirements including the size of the rotor core 16 and the maximum number of revolutions of the permanent magnet type rotating electrical machine 10.

Each of the permanent magnets (the south-pole magnets 20 and the north-pole magnets 21) is not restricted to a complete rectangular shape but may be a shape having chamfered corners.

Each coil 14 may be wound in either a concentrated manner or a distributed manner.

Therefore, the present examples and embodiments are to be considered as illustrative and not restrictive and the invention is not to be limited to the details given herein, but may be modified within the scope and equivalence of the appended claims.

1. A permanent magnet type rotating electrical machine comprising:
a stator;
a rotor core having a plurality of magnet inserting holes; and
a plurality of permanent magnets inserted in the magnet inserting holes and fixed to the rotor core, wherein
the permanent magnets include a plurality of north-pole magnets each having a north pole on a side opposed to the stator and a plurality of south-pole magnets each having a south pole on a side opposed to the stator,
each two adjacent south-pole magnets configure a first pair,
each two adjacent north-pole magnets configure a second pair,
the first and second pairs are fixed to the rotor core to be arranged alternately in a circumferential direction of the rotor core,
the magnet inserting holes include south-pole magnet inserting holes that accommodate the two south-pole magnets configuring the first pair and north-pole magnet inserting holes that accommodate the two north-pole magnets configuring the second pair,
the south-pole magnet inserting holes include a first magnet inserting hole that accommodates one of the two south-pole magnets and a second magnet inserting hole that accommodates the other one of the two south-pole magnets,
the north-pole magnet inserting holes include a first magnet inserting hole that accommodates one of the two north-pole magnets and a second magnet inserting hole that accommodates the other one of the two north-pole magnets,
in the first and second magnet inserting holes of the south-pole magnet inserting holes, the first magnet inserting hole has a first end opposed to the second magnet inserting hole, and the second magnet inserting hole has a second end opposed to the first magnet inserting hole,
in the first and second magnet inserting holes of the north-pole magnet inserting holes, the first magnet inserting hole has a first end opposed to the second magnet inserting hole, and the second magnet inserting hole has a second end opposed to the first magnet inserting hole,
the first magnet inserting hole and the second magnet inserting hole of the south-pole magnet inserting holes are configured identically with the first magnet inserting hole and the second magnet inserting hole of the north-pole magnet inserting holes, respectively,
each first magnet inserting hole and the corresponding second magnet inserting hole are spaced apart such that a partition wall is defined between the first end of the first magnet inserting hole and the second end of the second magnet inserting hole,
in a section of each of the first and second ends on an outer side in a radial direction of the rotor core, a bulging portion is arranged between a surface of the partition wall and a surface extending along the permanent magnet in the first magnet inserting hole or the second magnet inserting hole,
the bulging portion has a first curved surface continuous with the surface of the partition wall and a second curved surface continuous with the surface extending along the permanent magnet in the first magnet inserting hole or the second magnet inserting hole, and
the curvature of the first curved surface is smaller than the curvature of the second curved surface.

2. The permanent magnet type rotating electrical machine according to claim 1, wherein the two permanent magnets of at least one of the first pair and the second pair are arranged in a V shape spreading outward in the radial direction of the rotor core.

3. The permanent magnet type rotating electrical machine according to claim 1, wherein the two permanent magnets of at least one of the first pair and the second pair are arranged linearly.
